(19) United States
(12) Patent Application Publication
(10) Pub. No.: US 2002/0084975 A1
(43) Pub. Date: Jul. 4, 2002

(54) Method of processing surface for creating visual effect

(76) Inventor: Lion Lin, Kaohsiung (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 09/752,687

(22) Filed: Jan. 3, 2001

(51) Int. Cl. G09G 5/00

(52) U.S. Cl. 345/156

(57) ABSTRACT

A method of processing the surface of a product to create unique visual effect includes the steps of: fabricating a flat and smooth surface on the product; use silk screen printing or adhering sticker paper to form selected patterns on the surface to create bulged patterns thereof; use a sputtering module to sputter a metallic layer on the patterned surface; and coat a protection layer on the metallic layer to form a surface with three dimensional patterns and dazzling metallic gloss for increasing product value and appealing to facilitate product promotion.

### BACKGROUND OF THE INVENTION

This invention relates to method of processing surface for creating visual effect and particularly a method that employs silk screen printing (or sticker paper) to form patterns on a smooth surface of a product then sputter a metallic layer and coat a protection layer thereon to create appealing visual effect for product promotion purpose.

In the highly competitive market place nowadays, nearly all merchandise goods and commodities need proper package to attract consumer's attention. Most packages now being used have printing of all sorts of patterns and text or pictures to make the goods look attractive. For optical disks, the most commonly used method is to print mono or color patterns on the back surface (by means of lithographic printing or silk screen printing). The patterns produced by this type of printing is plain and dull, and has little added value. It is difficult to show high value and uniqueness of the goods, and is easy to be overlooked in the crowd of similar products. The competition in the High Tech market is especially fierce. The technology innovation leaps and bounds at a very fast speed, and product life cycle is very short. How to get a competitive edge to thrive or survive in the market place is a key issue nearly every producer is constantly focusing. Optical disk is a commodity in the high tech product market. How to package the optical disk so that it bears unique features to differentiate with other similar products and may stand out and looks attractive to consumers is an important object worth pursuing.

### SUMMARY OF THE INVENTION

It is therefore an object of this invention to provide a method that will give products an unique and appealing look to attract consumers. The method of this invention includes to use silk screen printing (or sticker paper) to form selected patterns on a flat and smooth surface of a product. Then sputter a metallic layer on the surface. After that, coat a protection layer over the surface so that the product will have a very attractive appearance. The finished package has unique visual effect and may help product promotion.

### BRIEF DESCRIPTION OF THE DRAWINGS

The invention, as well as its many advantages, may be further understood by the following detailed description and drawings, in which:

FIG. 1 is a process flow of this invention adapted for general products.

FIG. 2 is a top view of a product surface.

FIG. 3 is a top view of the product surface shown in FIG. 2, formed with selected patterns.

FIG. 4 is a magnified sectional view of the product surface shown in FIG. 3.

FIG. 5 is a top view of the product surface shown in FIG. 3 after sputtering with a metallic layer.

FIG. 6 is a top view of the product surface shown in FIG. 5 after coating with a protection layer.

FIG. 7 is a process flow of this invention adapted for optical disk.

### DESCRIPTION OF THE PREFERRED EMBODIMENT

This invention aims at providing a method for processing a product surface to create a three dimension and dazzling visual effect thereby to increase product appealing and value.

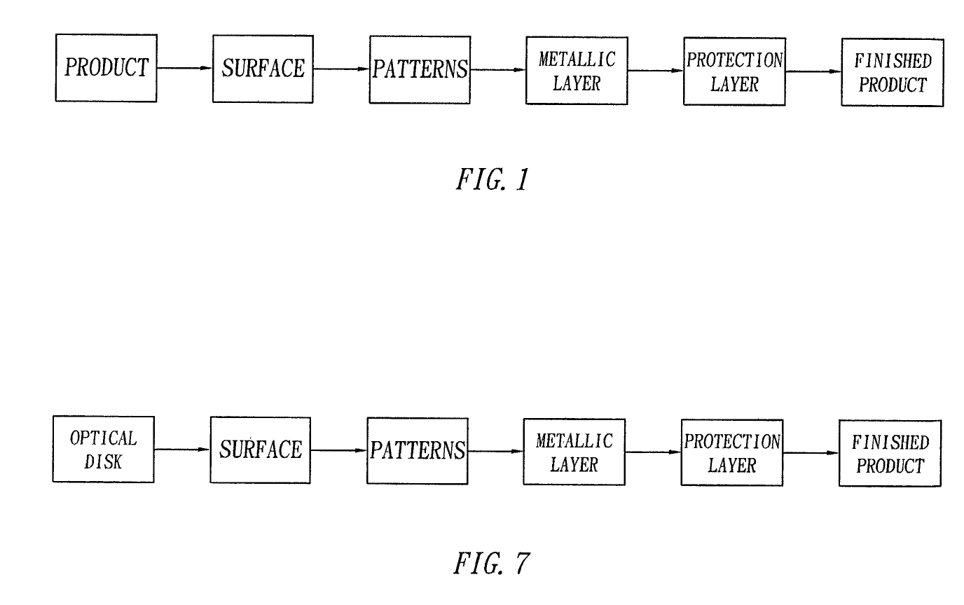

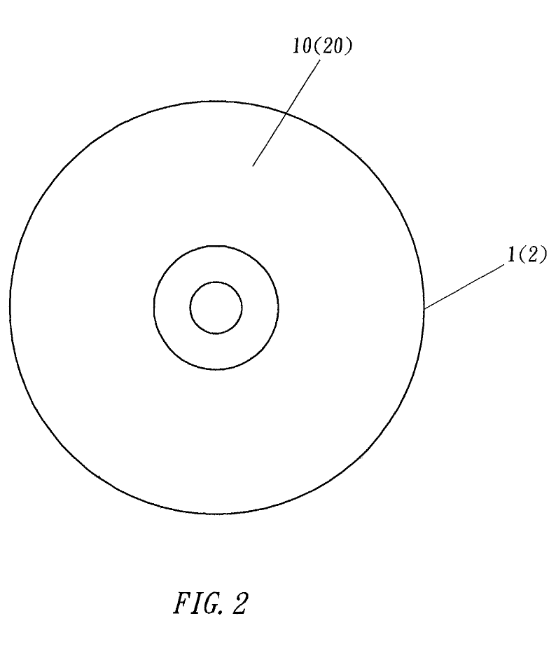

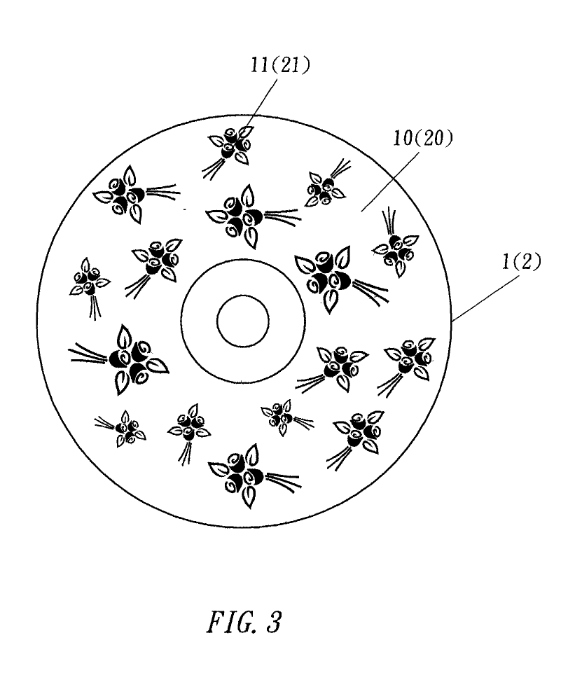

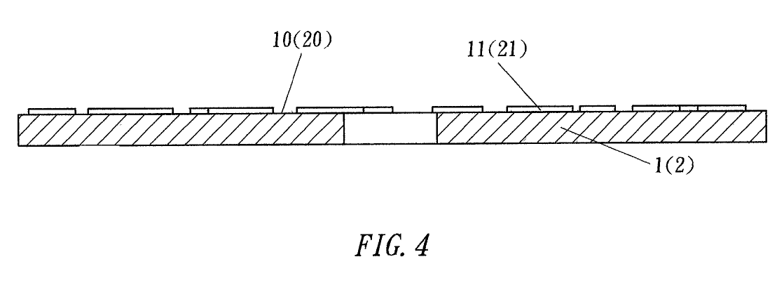

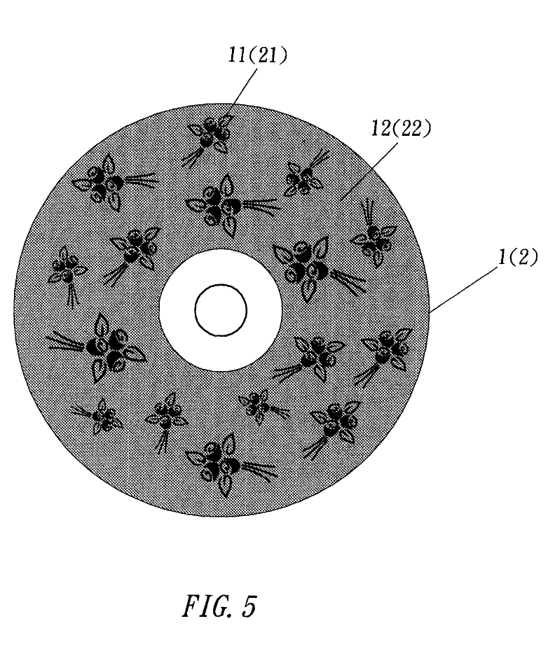

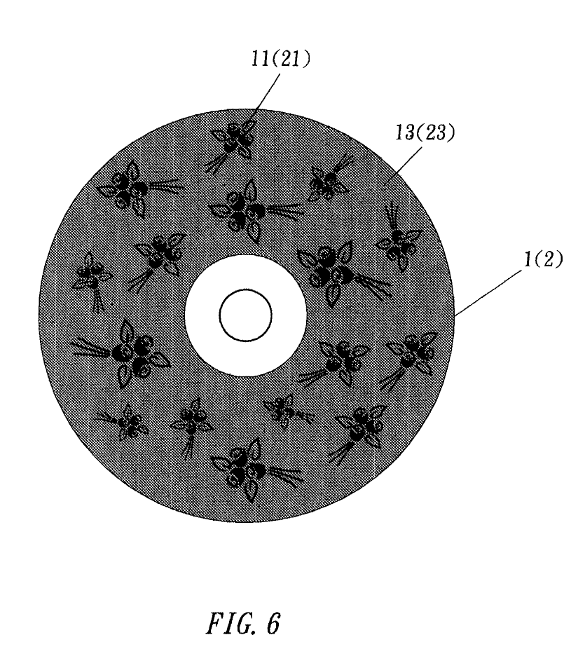

Referring to FIGS. 1 and 2, the method according to this invention includes the following steps: fabricate and prepare a flat and smooth surface 10 on a product 1; employ silk screen printing to form selected patterns 11 or text on the surface 10 (shown in FIG. 3) with the patterns 11 or text bulged upward to a selected thickness from the surface 10 (shown in FIG. 4); other suitable printing or forming techniques may also be used, such as merely print the contours of the patterns 11 or fill the patterns with proper materials after the contours are formed, or simply adhere the surface with preprinted sticker papers of selected patterns to form bulged patterns thereon; use a sputtering module to sputter the patterned surface evenly with a metallic layer 12 (shown in FIG. 5) in a vacuum chamber, the metallic layer material may be gold, silver, brass, aluminum, or other metal alloy with its original color or mating the patterns color; coat the metallic layer 12 with a transparent protection layer 13 (shown in FIG. 6) to prevent the metallic layer from oxidizing, scraping or peeling off, the material of the protection layer 13 may be acrylic resin or the like. Thus form the finished product which has the patterns 11 bulged out from the surface 10. When looking under light refraction, the product surface has three dimensional texture and may reflect dazzling metallic gloss and gives high value impression. As a result the product looks more appealing and has more promotional effectiveness.

FIG. 7 illustrates the method of this invention adapted to optical disk 2. The process includes: employ silk screen printing to form selected patterns 21 (shown in FIG. 3) or text or adhering sticker paper on the back surface 20 (shown in FIG. 2) with the patterns 21 or text bulged upward to a selected thickness from the surface 20 (shown in FIG. 4); use a sputtering module to sputter the patterned surface evenly with a metallic layer 22 (shown in FIG. 5) in a vacuum chamber to make the patterns 21 have three dimensional look and dazzling metallic gloss; coat the metallic layer 22 with a transparent protection layer 23 (shown in FIG. 6) to prevent the metallic layer from oxidizing, scraping or peeling off, the material of the protection layer 23 may be acrylic resin or the like. Thus form the finished optical disk 2 which has the patterns 21 bulged out from the back surface 20. When looking under light refraction, the optical disk back surface has three dimensional look and may reflect dazzling metallic gloss and gives the impression of high value. As a result the optical disk 2 may look more appealing and has more promotional effectiveness.

In summary, the method of this invention offers the following advantages:

1. This method may be applied to any product which has flat and smooth surface. It has wide applicability and may help product promotion.

2. The finished product has thee dimensional patterns and metallic gloss, and may increase product added value and create more effective advertising effect for attracting consumer attention.

3. The optical disk using the method of this invention to form patterns on the back surface may create unique visual effect and is more appealing, and may demonstrate high tech characteristics to facilitate product promotion.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of processing surface for creating visual effect, comprising the following steps:
a. fabricating a flat and smooth surface on a product;
b. forming selected patterns and text of a selected thickness on the surface for the patterns or text bulging out from the surface;
c. sputtering a metallic layer on the patterned surface to create a three dimensional appearance and metallic gloss; and
d. coating a protection layer on the metallic layer for preventing the metallic layer from oxidizing, scraping or peeling off.

2. The method of claim 1, wherein the product is an optical disk.

3. The method of claim 1, wherein the forming of selected patterns or text is done by silk screen printing.

4. The method of claim 1, wherein the forming of selected patterns or text is done by adhering patterned sticker paper on the surface.

5. The method of claim 1, wherein the metallic layer is selected from the group consisting of gold, silver, brass, aluminum, or the alloy thereof.

6. The method of claim 1, wherein the protection layer is acrylic resin.
